(19) United States
(12) Patent Application Publication
(10) Pub. No.: US 2023/0051526 A1
(43) Pub. Date: Feb. 16, 2023

(54) Method and Devices for Triggering Lawful Interception

(71) Applicant: Telefonaktiebolaget LM Ericsson (PUBL), Stockholm (SE)

(72) Inventors: Gennaro Oliviero, Naples (IT); Anna Rita D'Elia, Cave de' Torreni (IT); Lucia Savarese, Salerno (IT); Maria Pia Cancro, Salerno (IT); Rita Di Donato, Cava de' Tirreni (SA) (IT); Gino Ciccone, Aprilia (LT) (IT)

(21) Appl. No.: 17/785,746

(22) PCT Filed: Dec. 16, 2019
(86) PCT No.: PCT/IB2019/060869

§ 371 Date: Jun. 15, 2022

(51) Int. Cl. H04L 9/40

(52) U.S. Cl. CPC H04L 63/30

(57) ABSTRACT

Methods and apparatuses start lawful interception of an ongoing communication process in an after-handover network environment prior to completing an international handover of a user device. The user device is party of the ongoing communication process and an LI target. The user device being an LI target is determined based on the user device's identity, which is retrieved if the international handover is initiated.

### TECHNICAL FIELD

Embodiments of the subject matter disclosed herein generally relate to methods and apparatuses for triggering lawful interception (hereinafter LI) of an ongoing communication process in an after-handover network environment, if an international handover of a user device, which is a party in the ongoing communication process, is initiated.

### BACKGROUND

LI is the process of legally monitoring communication processes (voice and/or data) of selected individual network subscribers that are LI targets. Networks have to be configured to allow law enforcement agencies (LEAs) with legal authorization to record information and/or record content of LI targets' communication processes. Most countries require licensed network operators to implement software and hardware in their network environment for meeting predefined LI requirement.

Such implementations are standardized. FIG. 1, which is reproduced from a recent standard document (3GPP TS 33.108 entitled, “Handover interface for Lawful Interception,” release 15, version 15.6.0), is a logical representation of the functional entities achieving LI.

Within NWO/AP/SvP's domain 110, internal interception functions (IIF) 120 retain intercept-related information, IRI, and, optionally (depending on the type of the legal authorization), also content of communication, CC, related to any communication process in which an LI target is a party. Further, three functions that receive IRI and CC via internal network interface (INI) 121 intermediate communication with the LEA domain. The three functions are administration function 122, IRI mediation function 124 and CC mediation function 126. These functions feed an LI handover interface 129 to the legal enforcement monitoring facility (LEMF) 130. LI handover interface 129 has three ports (also named interfaces): HI1 for administrative information, HI2 for delivering IRI and HI3 for delivering CC (therefore, functions 124 and 126 are also known as delivery functions). Note that the functions in the NWO/AP/SvP's domain 110 may be executed by one or more network operator devices.

As illustrated in FIG. 2, a network user device 201 (e.g., a mobile phone, or any a user equipment) may be handed over (i.e., changing the serving network environment, for example, due to relocation) from a before-handover network environment 210 (i.e., the network environment serving the user device 201 before the handover) to an after-handover network environment 220 (i.e., the network environment serving the user device 201 is connected to after the handover). The handover process is suggested in FIG. 2 by the big arrow surrounding the network user device 201. The before-handover network environment 210 includes tower 212, base station/radio network controller, BS/RNC, 214 and mobile switching centre, MSC, 216. The after-handover network environment 220 includes tower 222, BS/RNC 224 and MSC 226. Conventionally, an LI started in the before-handover network environment continues in the before-handover network environment after the handover.

The MSC is a functional entity in charge with setting-up communication processes, releasing network resources when communication processes end and routing the calls. Therefore, the MSC (which is implemented on a device typically owned by a network operator) handles handovers for a network environment. Hereinafter, MSC 216 of the before-handover network environment is also called anchor MSC, while MSC 226 of the after-handover network environment is also called non-anchor MSC.

Conventionally (according to the standard), the non-anchor MSCs are configured not to start the LI activity even if the user device that is the subject of the handover is marked for interception. LI is started by the anchor MSC at call setup, if the user device is an LI target. After a call handover, the call continues to be monitored in the anchor-MSC. The standard does not foresee monitoring the user device in the non-anchor MSC involved in a later stage of the call, even if the user device is an LI target from the non-anchor MSC's perspective. This approach was designed to avoid a “double monitoring.”

If anchor MSC and non-anchor MSC are located in different countries (country A/country B) this approach becomes a limitation because monitoring in non-anchor MSC (country B) does not start even if requested by a local authority (i.e., LEA) different from the one before the handover. This inability of conventional non-anchor MSC to start LI activity in the after-handover network environment is a significant disadvantage creating an undesirable LI loophole.

The meanings of some abbreviations used in this document are explained below:

AP Access Provider

BS Base station

BSC Base station Controller

BSS Base station system

CC Content of communication

EDGE Enhanced Data rates for GSM Evolution

GERAN GSM EDGE Radio Access Network

GSM Global System for Mobile communications

IAM Initial Address Message

IRI Intercept-Related Information

IMEI International Mobile station Equipment Identity

IMSI International Mobile Subscriber Identity

ISDN Integrated Services Digital Network

LEA Law Enforcement Agency

LEMF Law Enforcement Monitoring Facility

LI Legal Interception

LTE Long Term Evolution

MAP Mobile Application Part

MS Mobile Station

MSC Mobile Switching Centre

3G_MSC 3^{rd} generation MSC

MSISDN Mobile Subscriber ISDN Number

NWO Network Operator

RNC Radio Network Controller

RNS Radio Network Subsystem

SRNS Serving Radio Network Subsystem

SRVCC Single Radio Voice Call Continuity

SvP Service Provider

UMTS Universal Mobile Telecommunications System

UTRAN UMTS Terrestrial Radio Access Network

VLR Visitor Location Register

WCDMA Wideband Code Division Multiple Access.

### SUMMARY

It is an object of the invention to trigger LI in the after-handover network environment in case of an international handover of an LI target in the after-handover network environment. The LI is triggered prior to completing the international handover of the LI target.

According to an embodiment, there is a method for triggering LI of an ongoing communication process by a network device pertaining to an after-handover network environment. The method includes retrieving a user device's identity if an international handover of a user device, which is a party in the ongoing communication process, is initiated. The method further includes determining whether the user device is an LI target in the after-handover network environment based on the user device's identity and triggering LI of the ongoing communication process prior to completing the international handover if the user device is the LI target.

According to another embodiment, there is a network device for triggering LI of an ongoing communication process in an after-handover network environment. The network device has a network interface configured to exchange messages related to an international handover of a user device, which is a party to the ongoing communication process, and a processor connected to the network interface. The processor is configured to retrieve the user device's identity if the international handover is initiated, to determine whether the user device is an LI target in the after-handover network environment based on the user device's identity, and to trigger LI of the ongoing communication process prior to completing the international handover if the user device is the LI target.

According to yet another embodiment there is a computer-readable recording medium non-transitorily storing executable codes, which, when executed by a processor connected to a network interface configured to exchange handover-related messages, makes the processor perform a method for triggering LI of an ongoing communication process in an after-handover network environment. The method includes retrieving a user device's identity if an international handover of the user device, which is a party in the ongoing communication process, is initiated. The method further includes determining whether the user device is an LI target based on the user device's identity and triggering LI of the ongoing communication process prior to completing the international handover if the user device is the LI target.

According to another embodiment, there is a computer program that, when executed by a processor connected to a network interface configured to exchange handover-related messages, makes the processor perform a method for triggering an LI prior to completing an international handover.

According to yet another embodiment, there is a network device including a transceiver configured to exchange messages related to an international handover of a user device, which is a party in an ongoing communication process. The network device further includes an identification module configured to retrieve the user device's identity, a decision module configured to determine whether the user device is an LI target based on the user device's identity, and an LI start module configured to trigger LI of the ongoing communication process prior to completing the international handover if the user device is the LI target.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a functional block diagram illustrating LI;

FIG. 2 illustrates handover of a network user device;

FIG. 3 illustrates a network view for an inter-MSC UTRAN/GERAN networks handover;

FIG. 4 illustrates an SRVCC network view handover;

FIG. 5 is a flowchart of a method according to an embodiment;

FIG. 6 illustrates implementation of the method in an inter-MSC handover according to an embodiment;

FIG. 7 illustrates a subsequent inter-MSC handover according to an embodiment;

FIG. 8 illustrates implementation of the method in an inter-3G_MSC SRNS relocation according to an embodiment;

FIG. 9 illustrates a subsequent inter-3G_MSC SRNS relocation handover according to an embodiment;

FIG. 10 is a block diagram of an apparatus according to another embodiment; and

FIG. 11 is a block diagram of an apparatus according to yet another embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The methods and network devices described hereinafter, allow LI to be started in an after-handover network environment if the handover is an international handover and the handed-over user device is LI target in the after-handover network environment. LI is started regardless whether LI has been started in the before-handover network environment.

An after-handover network device retrieves user device's identity if an international handover is initiated and determines whether the user device is an LI target using its identity. The network device triggers LI in the after-handover network environment prior to the international handover being completed if determined that the user device is indeed an LI target in the after-handover network environment.

The network device may be an MSC that is associated with communications switching functions, such as call set-up, release, and routing. Every MSC has its own LI target list disseminated by the LEA to which the network environment forwards the intercepted LI data (IRI and possibly also CC). The non-anchor MSC starts the LI before the international handover is completed.

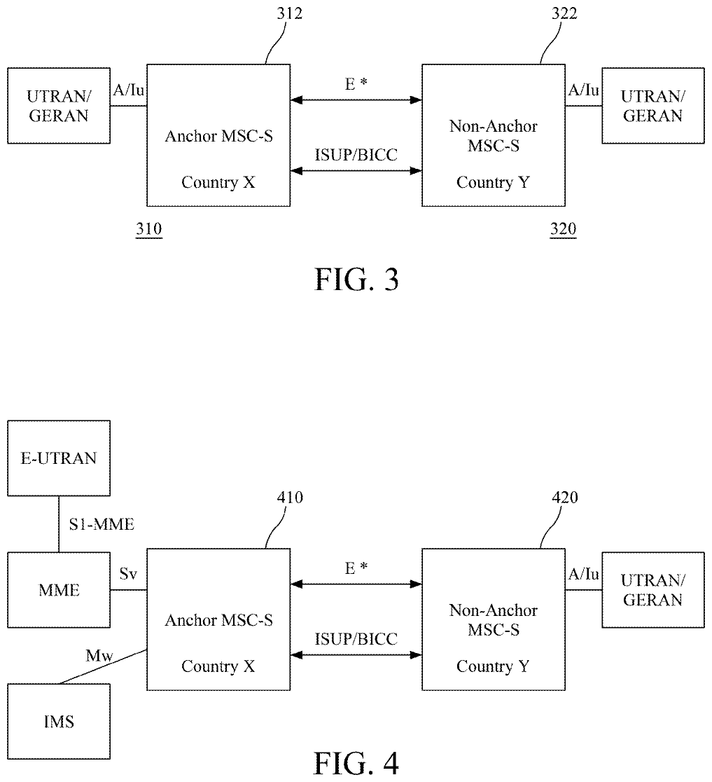

This approach (i.e., triggering LI in the after-handover network environment prior to completing the international handover) can be implemented in the following inter-MSC handovers: GSM to GSM, WCDMA to GSM, GSM to WCDMA and WCDMA to WCDMA. FIG. 3 illustrates a network view for such an inter-MSC handover from a before-handover network 310 with an anchor MSC 312 in country X to an after-handover network 320 with a non-anchor MSC 322. Here, both the before-handover network and the after-handover network are either UTRAN or GERAN networks. Note that MSC may not be part of the UTRAN or GERAN.

This same approach can be implemented for an LTE to GSM/WCDMA handover (SRVCC as described, for example, in standard document 3GPP TS 23.216 entitled, “Single Radio Voice Call Continuity (SRVCC),” release 15, version 15.3.0). FIG. 4 illustrates a network view for such an international handover with anchor MSC 410 and non-anchor MSC 420 pertaining to different countries. In FIGS. 3 and 4, E* is an interface between the before-handover MSC and the after-handover MSC. Interface E* enables exchange of handover-related messages and may use a MAP/E protocol.

Triggering LI in the after-handover network environment prior to completing an international handover solves the problem of LI avoidance by crossing a country border. LEAs welcome the ability to reliably monitor and track an LI target crossing a country border. Network operators are also pleased to comply with regulatory requirements so as to not risk being fined or having their license revoked.

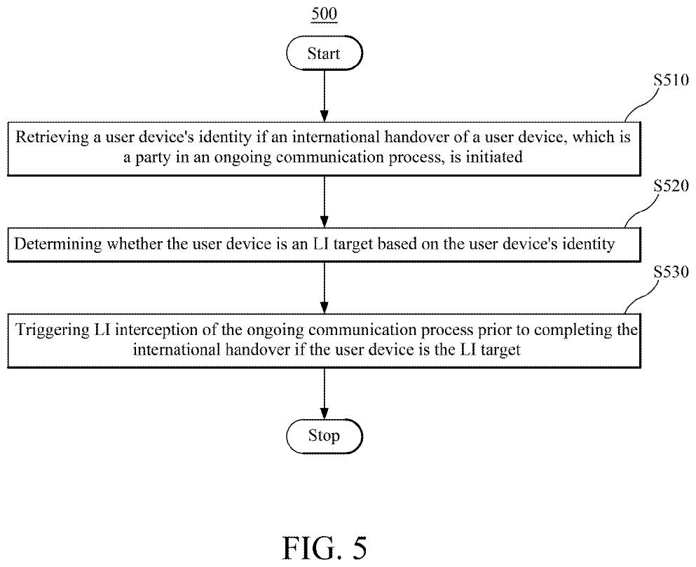

FIG. 5 is a flowchart of a method 500 according to an embodiment. Method 500 aims to trigger LI of an ongoing communication process (such as but not limited to a call) and is performed by an after-handover network device (such as 322 or 420). Method 500 includes retrieving a user device's identity if an international handover of a user device that is a party in the ongoing communication process is initiated at S510.

The user device's identity may be specified via MSISDN, IMEI and/or IMSI. In other words, the user device's identity shall, within the meaning of the description and claims, be interpreted as an identity which includes an identity of a wireless telecommunication network subscriber which/who has its Subscriber Identity Module (SIM)/UICC as a part (either removably connected or embedded/integrated) of the user device and wherein the IMSI is stored. Additionally, location information is available in the case of international handover, and it is reported via a standardized XI2 interface.

Further, method 500 further includes determining whether the user device is an LI target based on the user device's identity at S520, and, triggering LI of the ongoing communication process prior to completing the international handover if the user device is the LI target at S530.

The user device's identity may include an IMSI and an IMEI retrieved from an initial address message, IAM, received from the before-handover network device. Alternatively, the user device's identity may be reconstructed from information in a MAP-Prepare-Handover request received from the before-handover network device.

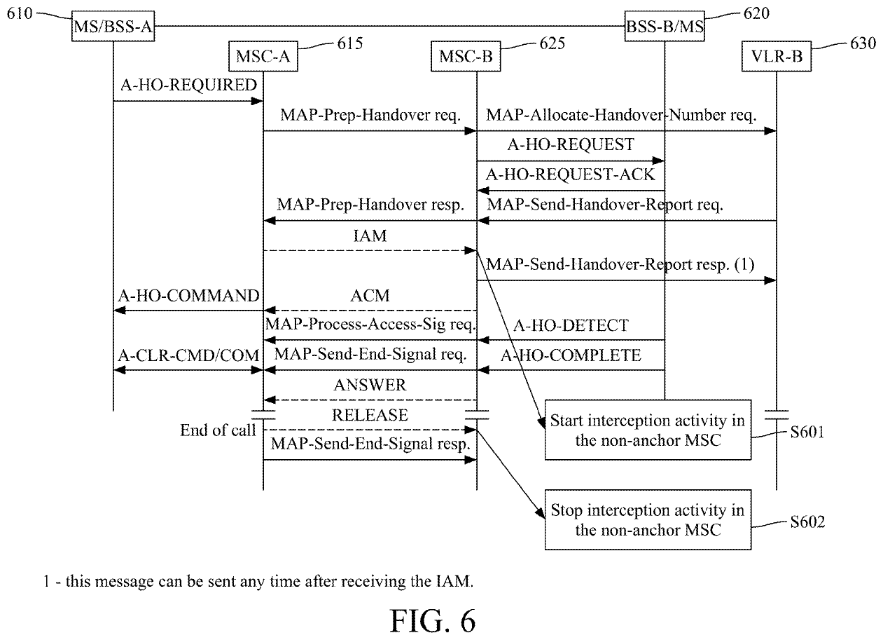

FIG. 6 illustrates implementation of the method in an inter-MSC handover according to an embodiment. In the scenario illustrated in FIG. 6 (time flowing from top down), a user device (not shown) is subject to an international handover from BSS-A 610 to BSS-B 620. MSC-A 615 is an anchor MSC, and MSC-B 625 is a non-anchor MSC. VLR-B 630 is a visitor location register. The conventional handover (i.e., not having the method implemented) is illustrated as a basic handover procedure in 3GPP TS 23.009 entitled, “Handover procedures,” release 15, version 15.0.0. Different from the conventional handover, according to the embodiment illustrated in FIG. 6, MSC-B 625 starts LI at S601 after receiving the initial address message, IAM, from MSC-A 615. LI is triggered at S601 if, based on the user device's identity retrieved from IAM, MSC-B 625 determines that the user device is an LI target in the after-handover network environment. When the call ends and the network resources are released, MSC-B stops the LI at S602.

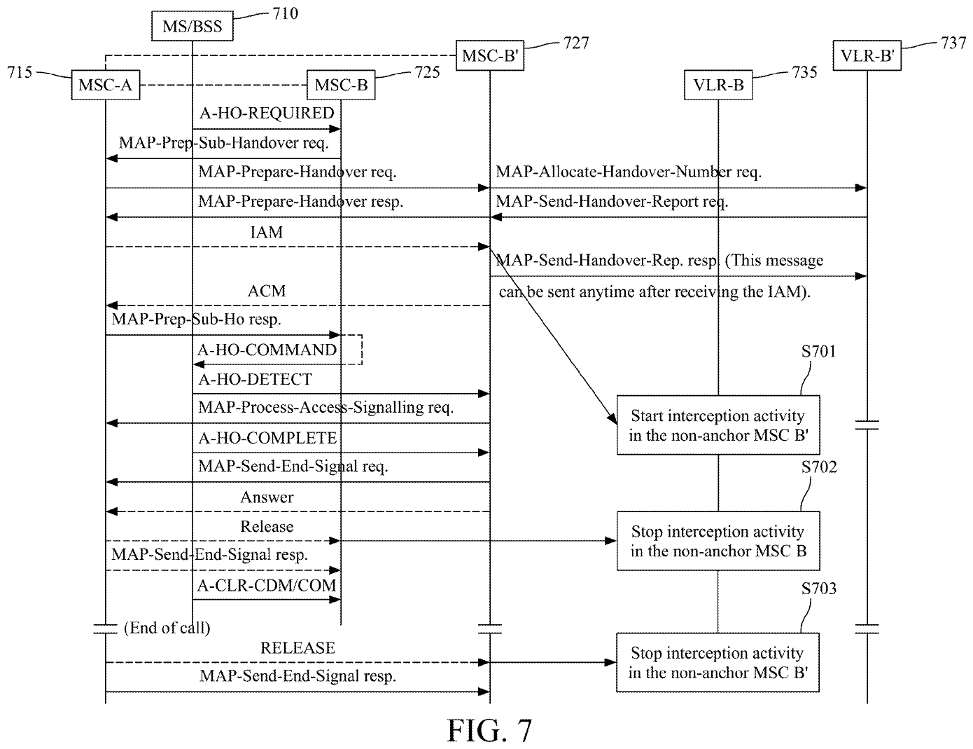

Further, FIG. 7 illustrates a scenario with a subsequent inter-MSC handover, that is, from MSC-B 725 to MSC-B′ 727 (VLR-B 735 and VRL-B′ 737 being respective visitor location registers). The conventional subsequent handover (i.e., not having the method implemented) is illustrated in the above-mentioned 3GPP TS 23.009. In the scenario illustrated in FIG. 7, LI has been started by MSC-B 725 as described above based on FIG. 6. Both MSC-B 725 and MSC-B′ 735 are connected to MS/BSS 710.

MSC-B′ 727 starts LI in the after-handover network environment at S701 after receiving the IAM from MSC-A 715. After the subsequent handover, MSC-B′ 727 replaces MSC-B 725, all LI activities being terminated in MSC-B 725 at S702 while continuing in MSC-B′ 727. When the call ends and the network resources are released, MSC-B′ 727 stops the LI at S703.

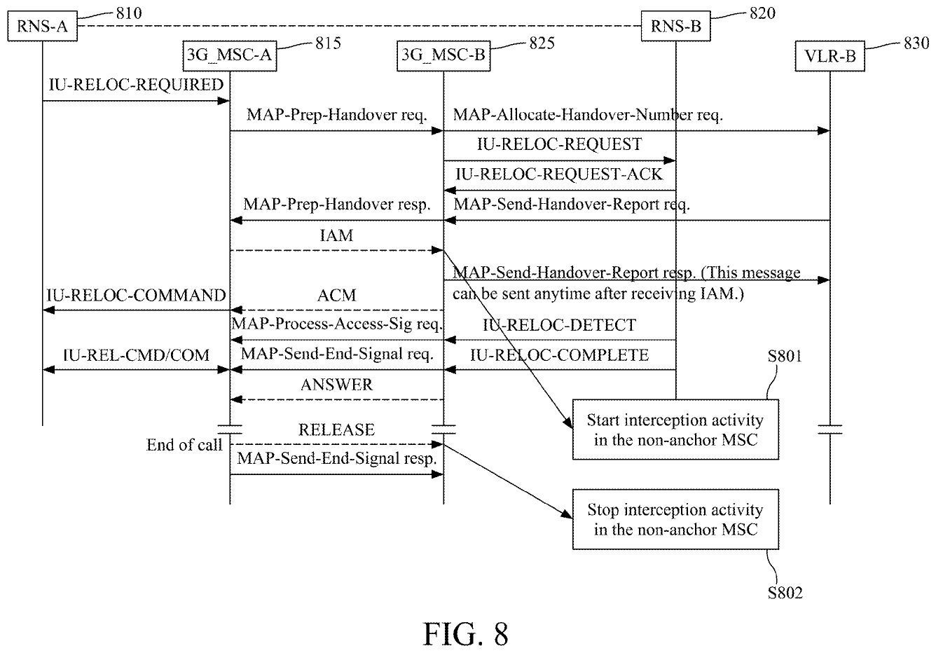

FIG. 8 illustrates implementation of a method in an inter-3G_MSC SRNS relocation scenario according to an embodiment. The conventional handover (i.e., not having the method implemented) is also illustrated in 3GPP TS 23.009. In the scenario illustrated in FIG. 8 (again, time flowing from top down), a user device (not shown) is handed over from RNS-A 810 to RNS-B 820. In this embodiment, 3G_MSC-B 825 starts the LI (i.e., the LI is triggered in the after-handover network environment) at S801, after receiving the IAM from 3G_MSC-A 815. When the call ends and the network resources are released, 3G_MSC-B 825 stops the LI at S802.

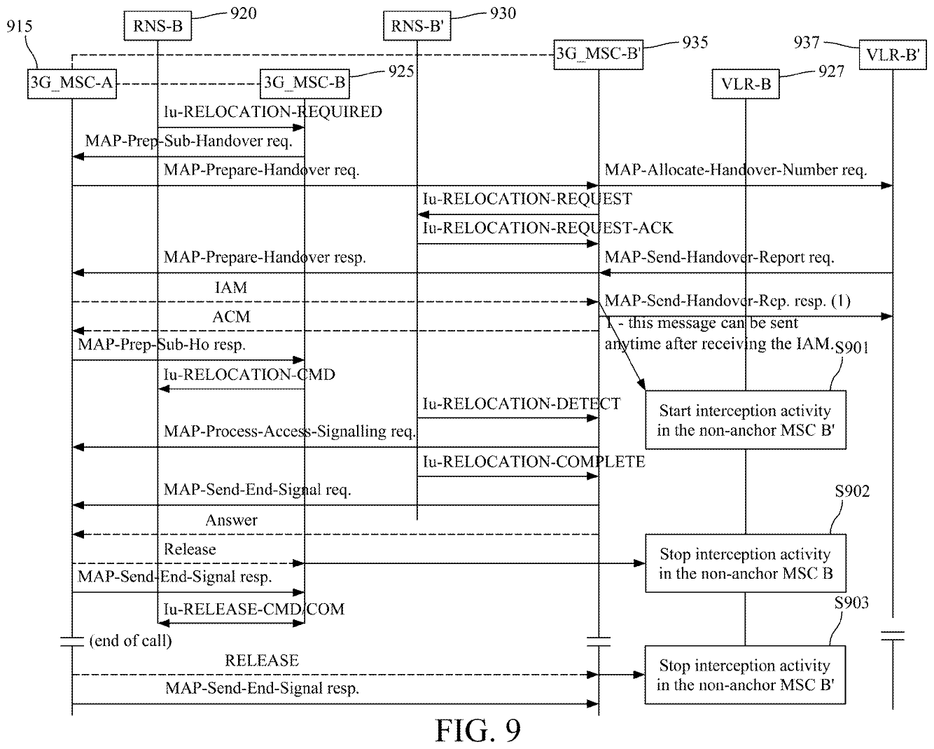

Further yet, FIG. 9 illustrates a scenario with a subsequent inter-3G_MSC SRNS relocation from RNS-B 920 with 3G_MSC-B 925 to RNS-B′ 930 with 3G_MSC-B′ 935 (VLR-B 927 and VRL-B′ 937 being respective visitor location registers). The conventional subsequent Inter-3G_MSC SRNS relocation (i.e., not having the method implemented) is illustrated in the above-mentioned 3GPP TS 23.009. Both MSC-B 725 and MSC-B′ 735 are connected to MS/BSS 710.

In the scenario illustrated in FIG. 8, 3G_MSC-B′ 935 starts LI at S901 after receiving the IAM from 3G_MSC-A 915. After the subsequent Inter-3G_MSC SRNS Relocation, 3G_MSC-B′ 935 replaces 3G_MSC-B 925, all LI activities being terminated in 3G_MSC-B 925 at S902 and continuing in 3G_MSC-B′ 935. When the call ends and the network resources are released, 3G_MSC-B′ 935 stops the LI at S903.

At reception of MAP-Prep-Handover request message, the non-anchor MSC may determine (and store) the type of handover (i.e., whether the handover is international) by comparing anchor and non-anchor MSC addresses. If the handover is international, the non-anchor MSC stores the following information related to user device subject of the handover process: IMSI obtained from MAP-Prep-Handover request message, and IMEI, obtained from IMEISV, received in MAP-Prep-Handover request message. The IMSI and IMEI are associated with a handover number instantiated for the call and returned in MAP-Prep-Handover response message.

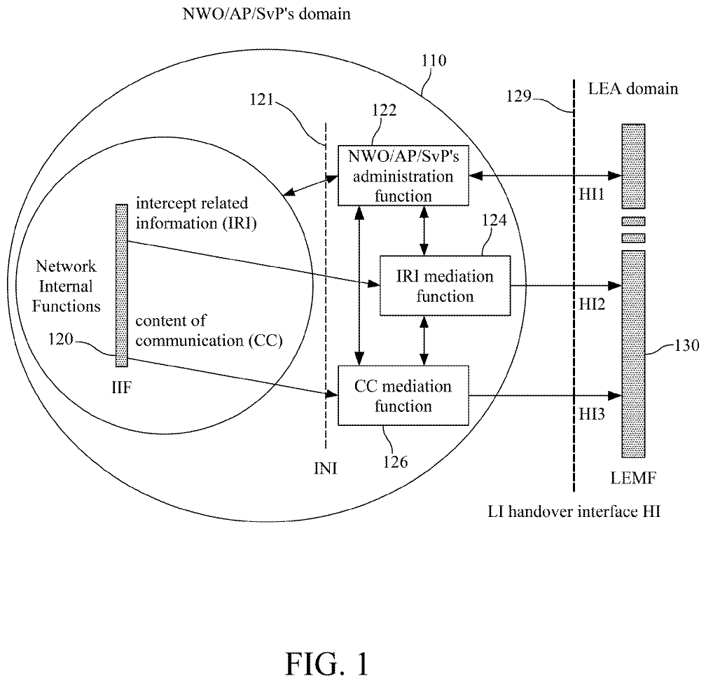

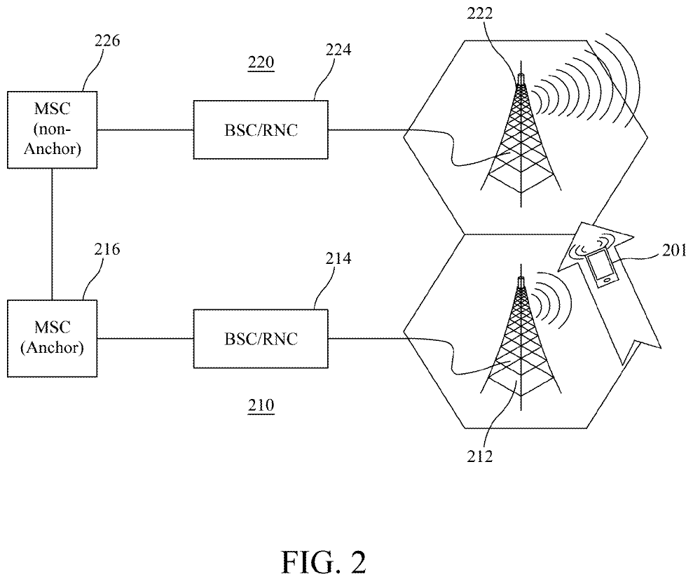

Then, at reception of IAM, the non-anchor MSC starts LI if MSISDN (determined using the Calling Party Number received in IAM) or IMSI/IMEI (associated to handover number received as Called Party Number in IAM) is marked for monitoring. The IRI and, if it is required, also CC, are delivered to the LEMF via the delivery functions (e.g., 124, 126 in FIG. 1).

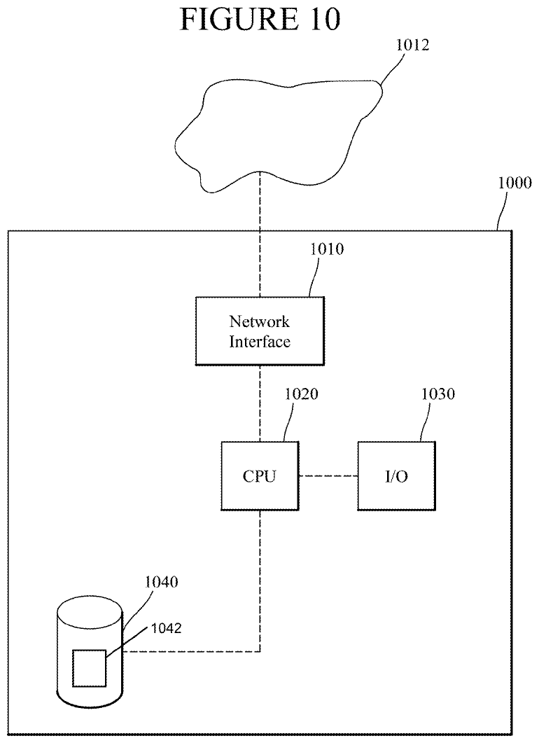

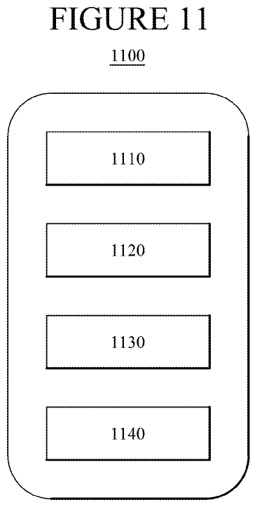

FIG. 10 is a schematic diagram of an apparatus 1000 according to an embodiment. Apparatus 1000 includes a communication interface 1010 and a processing unit 1020. The communication interface is configured to receive and transmit messages related to an international handover of a user device via network 1012.

Data processing unit 1020 is configured to retrieve a user device's identity, if an international handover of the user device is initiated. Data processing unit 1020 is further configured to determine, based on the user device's identity, whether the user device is an LI target in the after-handover network environment, and to initiate interception of user device's communications prior to completing the international handover if the UE is the LI target.

Apparatus 1000 may also include a memory 1040 and an operator interface 1030. Memory 1040 may store executable codes or a program (1042), which, when executed by the processing unit, make the processing unit perform any of the methods described in this section.

FIG. 11 is a block diagram of an apparatus 1100 according to another embodiment. Apparatus 1100 includes a transceiver 1110 configured to exchange messages related to an international handover of a user device, and an identification module 1120 configured to retrieve a user device's identity when the international handover of the user device is initiated.

Apparatus 1100 further includes a decision module 1130 configured to determine whether the user device is an LI target in the after-handover network environment based on the user device's identity, and an LI start module 1140 configured to initiate LI of user device's communications prior to completing the international handover if the user device is LI target in the after-handover network environment. Modules 1120, 1130 and 1140 may be implemented on one or more processors and other electronic circuits.

Thus, the embodiments disclosed in this section provide methods and network devices for triggering LI of an ongoing communication process in an after-handover network environment if a user device subject to an international handover is LI target in the after-handover environment. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1.-19. (canceled)

20. A method for triggering a lawful interception, LI, of an ongoing communication process, the method being performed by a network device pertaining to an after-handover network environment, the method comprising:
determining a type of handover, by comparing anchor and non-anchor MSC address, at reception of a MAP-Prep-Handover request message, wherein a type of handover comprises an international handover;
retrieving a user device's identity if an international handover of a user device, which is a party in the ongoing communication process, is initiated,
wherein the user device's identity includes an international mobile subscriber identity, IMSI, and an International Mobile Equipment Identity, IMEI,
and IMSI and IMEI are received in a MAP-Prepare-Handover request received from the before handover network environment;
storing, the IMSI and the IMEI, if the handover is international;
determining whether the user device is an LI target in the after-handover network environment, based on the user device's identity; and
triggering LI of the ongoing communication process in the after-handover network environment prior to completing the international handover if outcome of the determining is the user device is the LI target, at reception of an initial address message, IAM.

21. The method of claim 20, wherein the after-handover network device is a mobile switching centre, MSC.

22. The method of claim 20, wherein the after-handover network is a universal mobile telecommunications system, UMTS, terrestrial radio access network, UTRAN, a global system for mobile communications, GSM, Enhanced Data rates for GSM Evolution, EDGE, radio access network, GERAN or a third generation of wireless mobile telecommunications, 3G, network.

23. The method of claim 20, wherein the user device's identity includes a mobile subscriber Integrated Services Digital Network number, MSISDN.

24. The method of claim 20, wherein the MSISDN is retrieved from an initial address message, IAM, received from the before-handover network environment.

25. The method of claim 20, wherein the triggering comprises activating delivery of intercept related information, IRI, to an IRI delivery function (124) that forwards the IRI to a legal enforcing monitoring facility, LEMF.

26. The method of claim 20, the triggering comprises activating delivery of content of communication, CC, to a CC delivery function that forwards the CC to the LEMF.

27. A network device for triggering a lawful interception, LI, of an ongoing communication process in an after handover network environment, the network device comprising:
a network interface configured to exchange messages related to an international handover of a user device, which is a party to the ongoing communication process; and
a processor connected to the network interface and configured
to determine a type of handover, by comparing anchor and non-anchor MSC address, at reception of a MAP-Prep-Handover request message, wherein a type of handover comprises an international handover;
to retrieve a user device's identity if the international handover is initiated, wherein the user device's identity includes an international mobile subscriber identity, IMSI, and an International Mobile Equipment Identity, IMEI,
and IMSI and IMEI are received in a MAP-Prepare-Handover request received from the before handover network environment;
to store, the IMSI and the IMEI, if the handover is international;
to determine whether the user device is an LI target in the after handover network environment, based on the user device's identity, and
to trigger LI of the ongoing communication process prior to completing the international handover, if the user device is the LI target, at reception of an initial address message, IAM.

28. The network device of claim 27, wherein the network device is a mobile switching centre, MSC.

29. The network device of claim 27, wherein the after-handover network is a universal mobile telecommunications system, UMTS, terrestrial radio access network, UTRAN, a global system for mobile communications, GSM, Enhanced Data rates for GSM Evolution, EDGE, radio access network, GERAN or a third generation of wireless mobile telecommunications, 3G, network.

30. The network device of claim 27, wherein the user device's identity includes mobile subscriber integrated services digital network number, MSISDN.

31. The network device of claim 27, wherein the MSISDN is retrieved from an initial address message, IAM, received from the before-handover network environment.

32. The network device of claim 27, wherein, when triggering the LI, the processor activates delivery of intercept related information, IRI, to an IRI delivery function that forwards the IRI to a legal enforcing monitoring facility, LEMF.

33. The network device of claim 27, wherein, when triggering the LI, the processor activates delivery of content of communication, CC, to a CC delivery function that forwards the CC to the LEMF.

34. A computer-readable recording medium non-transitorily storing executable codes, which, when executed by a processor connected to a network interface, which is configured to exchange handover-related data via a network, makes the processor perform, a method comprising:
determining a type of handover, by comparing anchor and non-anchor MSC address, at reception of a MAP-Prep-Handover request message, wherein a type of handover comprises an international handover;
retrieving a user device's identity when an international handover of a user device, which is a party in the ongoing communication process, is initiated, wherein the user device's identity includes an international mobile subscriber identity, IMSI, and an International Mobile Equipment Identity, IMEI,
and IMSI and IMEI are received in a MAP-Prepare-Handover request received from the before handover network environment;
storing, the IMSI and the IMEI, if the handover is international;
determining whether the user device is an LI target in an after-handover network environment based on the user device's identity; and
triggering LI of the ongoing communication process in the after-handover network environment prior to completing the international handover if the user device is the LI target, at reception of an initial address message, IAM.
